(19) United States
(12) Patent Application Publication
(10) Pub. No.: US 2004/0013960 A1
(43) Pub. Date: Jan. 22, 2004

(54) Single-layered electrophotographic photoreceptor, method, catridge and drum therefor

(75) Inventors: An-Kee Lim, Uiwang-city (KR); Hwan-Koo Lee, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/601,859

(22) Filed: Jun. 24, 2003

(30) Foreign Application Priority Data
Jul. 10, 2002 (KR) 2002-40105

(51) Int. Cl. G03G 5/05; G03G 5/06

(52) U.S. Cl. 430/78; 430/72; 430/56; 430/96; 430/133; 399/159

(57) ABSTRACT

A single-layered electrophotographic photoreceptor has a single-layered structure that includes a charge generating material, a charge transfer material, and a binder resin on a substrate. In one embodiment, the charge generating material is Y form titanyloxy phthalocyanine, and the binder resin is polyethylene terephthalate polymer. The single-layered electrophotographic photoreceptor has excellent stability, electrical characteristics, sensitivity and durability, and may be installed in a cartridge or on a drum of an image forming apparatus.

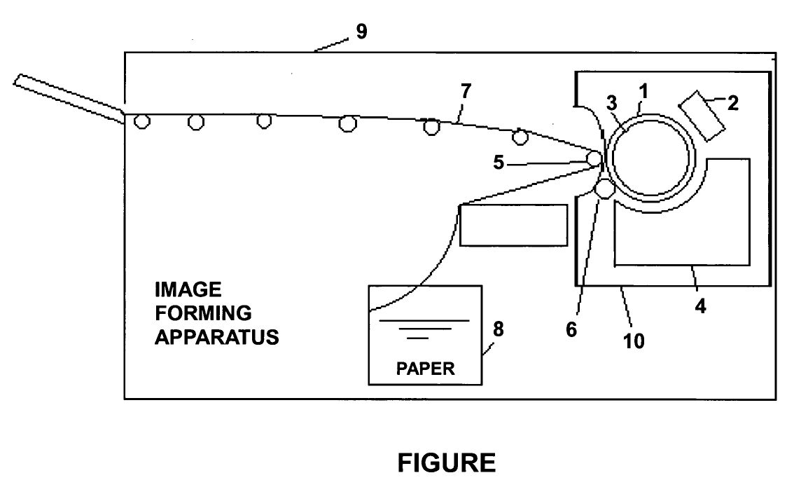

### CROSS-REFERENCE TO RELATED APPLICATIONS

This application claims the benefit of Korean Application No. 2002-40105, filed Jul. 10, 2002, in the Korean Intellectual Property Office, the disclosure of which is incorporated herein by reference.

### BACKGROUND OF THE INVENTION

1. Field of the Invention

The present invention relates to a single-layered electrophotographic photoreceptor, and more particularly, to a single-layered electrophotographic photoreceptor which is made of a titanyloxy phthalocyanine crystal form as a charge generating material and a polyethylene terephthalate polymer as a main binder resin.

2. Description of the Related Art

An electrophotographic photoreceptor is generally made of an inorganic photoreceptor as a charge generator. However, the inorganic photoreceptor has some drawbacks in that it is expensive and causes environmental pollution. In order to overcome these drawbacks, many trials and studies have been conducted, mainly with respect to the electrophotographic photoreceptor made of an organic light-electric conductive material. A photoreceptor layer of an organic electrophotographic photoreceptor is formed by dispensing an organic light sensitive-electrically conductive material on a resin. Many suggestions have been made with respect to the structure of the organic electrophotographic photoreceptor layer, such as forming a multi-layered structure that has a charge generating layer that is formed by dispersing the charge generating material on a resin and that has a charge transferring layer that is formed by dispersing a charge transferring material on a resin, or forming a single-layered structure in which a charge generating material and a charge transferring material are dispersed on a resin concurrently.

In these organic light-electric conductive materials, certain materials are known to have a sensitivity to the light of a semi-conductor, which are a naphthaquinone group, an azo group and phthalocyan group compounds. In particular, the phthalocyan group compounds are used as a blue pigment for ink, paints, etc., and have been studied widely as a charge generating material.

Generally, the phthalocyan compounds have different UV-absorption spectrums or electrical characteristics depending on the identity of the central metals. Even the phthalocyan compounds with the same central metal also have different UV-absorption spectra or electrical characteristics depending on individual form or size, and the phthalocyan compounds have different characteristics as a charge generating material depending on UV-absorption spectra or electrical characteristics. There are non-metal phthalocyanine, chloroaluminum phthalocyanine, chlorogermanium phthalocyanine, titanyloxy phthalocyanine (TiOPc) in the phthalocyan-charge generating materials. Among them, TiOPc has a higher light-sensitivity and more diverse crystal forms than other phthalocyanine compounds. For example, according to the crystal forms of TiOPc, there are α type TiOPc, β type TiOPc, I type TiOPC, and Y type TiOPc.

These phthalocyan charge generating materials are produced and then condensed into a crystal form in which a first particle is condensed to a size of several tens of microns. The phthalocyan compound having a condensed crystal form is dispersed and micronized. Then, a dispersion coating liquid is produced from the dispersed crystal form, and the dispersion coating liquid is spread and used as a film on a conductive substrate, with the phthalocyan material serving as a charge generating material.

If a charge generating material in the dispersion coating liquid becomes a macro-particle due to a transformation of the crystal form, growth or a condensation of the crystal, the electrophotographic characteristic deteriorates, or a local inequality in electronic characteristics of the film is caused. Also, with respect to the image quality, an image defect such as black spots or fogging, may cause degradation of resolution. Accordingly, the charge generating material needs to maintain stability against a change in crystal form, such as a growth or a condensation of the crystal.

The binder resin disperses the pigments and allows pigment particles to bind evenly to an aluminum drum. Generally, polyvinyl butyral resin, polycarbonate resin, polymethyl acryl resin, or polyvinylyden chloride resin may be used for the binder resin. A photoreceptor of an organic light sensitive-electrically conductive material is the portion of an image forming apparatus that is frequently rubbed against papers, an electrostatic charge roller, a printing roller, and a developing roller. Accordingly, the film of the photoreceptor will experience damage and degradation of the electrostatic characteristics if the strength of the photoreceptor is weak. Especially, when the polycarbonate resin is used for the binder resin, the photoreceptor will weaken, and the electrostatic characteristics of the photoreceptor subsequently degrade since the photoreceptor is apt to dissolve in a paraffin oil, which may be used as the solvent of a liquid toner of a printing device.

One of the conventional methods uses the dispersion coating liquid, including the phthalocyan compound as the charge generating material, which is represented by the following general formula:

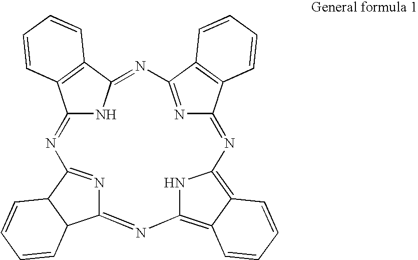

The dispersion coating liquid is produced by dispersing the X-form H₂Pc as the charge generating material together with a polymer such as polyvinyl butyral resin, polyvinyl acetate resin, or the like in a range of concentration of 13 wt % to 25 wt %. However, this kind of dispersion coating liquid has been shown to be too difficult to be used for a single-layer electrophotographic photoreceptor and has a rather unsatisfying light sensitivity as a photoreceptor.

The conventional phthalocyan group charge generating material can provide an excellent sensitivity immediately after production. However, because the crystal characteristic of the coating liquid state varies by time, the conventional phthalocyan group charge generating material has shortcomings such as quality instability, low productiveness, high costs, etc.

Further, demand for a dispersion coating liquid, which is suitable for a single-layered electophotographic photoreceptor suspended in the binder resin and allows sufficient resistance of the photoreceptor of the organic photoreceptor drum, has been constantly increased.

### SUMMARY OF THE INVENTION

Therefore, it is an aspect of the present invention to provide an improved single-layered electrophotographic photoreceptor which is made of titanyloxy phthalocyanine crystal form as a charge generating material and polyethylene terephthalate polymer as a main binder resin.

Additional aspects and advantages of the invention will be set forth in part in the description which follows and, in part, will be obvious from the description, or may be learned by practice of the invention.

To accomplish the above and/or other aspects, a single-layered electrophotographic photoreceptor comprising a charge generating material, a binder resin and a charge transfer material is utilized, wherein the charge generating material is titanyloxy phthalocyanine, a compound having a structure represented by the below-mentioned formula (General Formula 2):

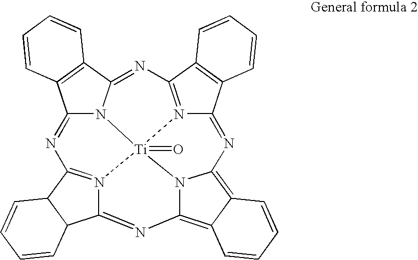

The titanyloxy phthalocyanine is a crystal form which has at least 2 main peaks in the range of (2θ+−0.2)=9.5° to 27.3° of the Bragg angle in the characteristic CuKα X-ray diffraction spectrum.

The binder resin is polyethylene terephthalate polymer of the following formula:

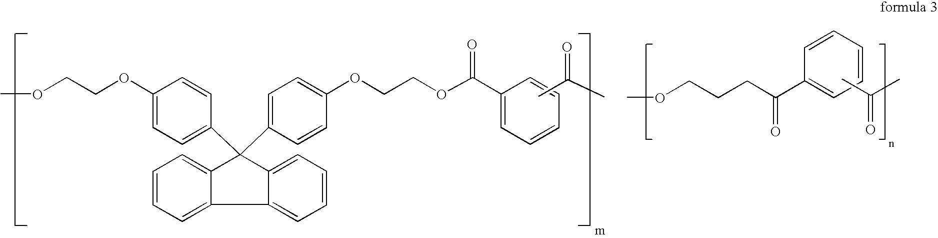

wherein n and m are each an integer equal to, or greater than, 1.

Alternatively, the binder resin can be a mixture of polycarbonate and polyethylene terephthalate polymer mixed in a ratio of 1:99 to 99:1 by weight.

The charge transfer material includes both a positive hole transfer material and a electron transfer material. In an embodiment of the present invention, the positive hole transfer material is enaminstylbene polymer, and the electron transfer material is 9-dicyanomethylene-9H-fluorene-4-carboxylic butyl ester which has the following formula:

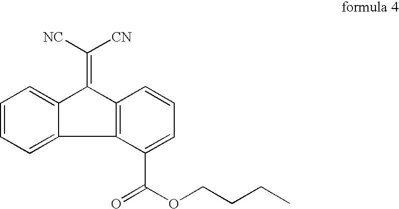

In the present invention, the single-layered electrophotographic photoreceptor includes the charge generating material in dispersion liquid. The dispersion liquid comprises the charge generating material, 1,1,2-trichloroethane as a solvent, and polycarbonate of the following (formula 5) as a binder resin:

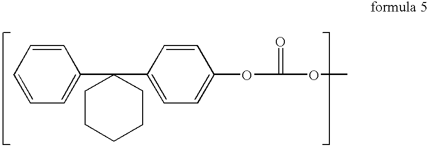

wherein the polycarbonate is preferably in the range of 10 wt % to 90 wt %, and more preferably, the polycarbonate is in the range of 10 wt % to 40 wt %.

It is preferable to maintain the temperature below 15° C. while milling the dispersion liquid, and more preferably, below 5° C.

### BRIEF DESCRIPTION OF THE DRAWINGS

These and/or other aspects and advantages of the present invention will become apparent and more readily appreciated from the following description of the embodiments, taken in conjunction with the accompanying drawing:

FIGURE is a block diagram of an embodiment of a single-layered electrophotographic photoreceptor cartridge/drum and an image forming apparatus in accordance with an embodiment of the single-layered electrophotographic photoreceptor of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to the present invention, at first, a dispersion liquid including a charge generating material is prepared. Then a binder resin and a charge transfer material are added to the dispersion liquid, and the dispersion coating liquid for the single-layered electrophotographic photoreceptor is prepared.

The charge generating material used in the present invention is titanyloxy phthalocyanine, which has a higher sensitivity than non-metal phthalocyan. As for the titanyloxy phthalocyanine crystal form, the present invention uses Y-form titanyloxy phthalocyanine that has at least two main peaks characterized in the range of (2θ+−0.2)=9.5° to 27.3° of the Bragg angle in the characteristic CuKα X-ray diffraction spectrum.

Titanyloxy phthalocyanine is dispersed together with binder resin and solvent. Here, the binder resin can be polyvinylbutyral resin, polyvinyl alcohol resin, polyamide resin, polyvinyl acetate resin, polyvinyl chloride resin, polyacryl resin, polyurethane resin, polycarbonate resin, polymethylacryl resin, polyvinylidene chloride resin, polystyrene resin, etc., or can be a mixture of at least two of the above. Preferably, polycarbonate resin is used.

According to the present invention, the solvent of the dispersion liquid may be 1,1,2-trichloroethane, 1,2-dicholroethane, monochlorobenzene, methylbenzene, ethylbenzene, anisol, etc., or may be a mixture thereof. It is preferable to use 1,1,2-trichloroethane.

In an embodiment of the present invention, the Y-form titanyloxy phthalocyanine is dispersed for more than 1 hour with a dispersing machine, with the addition of a binder resin and a solvent and a dispersing material selected from glass beads, steel beads, zirconia beads, alumina beads, zirconia balls or steel balls. Here, the dispersing machine may be a high-speed agitator, a paint shaker, a ball mill, a sand mill, a dyno mill, a two roll mill, a three roll mill, a supersonic pulverizer, a ultimizer, etc. Finally, the dispersion liquid can be obtained by straining out the beads used for the milling through a sieve.

The charge transfer material including the positive hole transfer material, the electron transfer material, and the binder resin, are mixed. Then, after the mixture is dissolved with the solvent, the dispersion coating liquid is obtained by adding the dispersion liquid to the mixture solution. Preferably, the positive hole transfer material is enaminstylbene, and the electron transfer material is 9-dicyanomethylene-9H-fluorene-4-carboxylic butyl ester.

The binder resin of the dispersion coating liquid may be a polyethylene terephthalate polymer, differing from the binder resin of the dispersion liquid. Finally, the single-layered electrophotographic photoreceptor is obtained by coating the dispersion coating liquid on the substrate, for example, on the aluminum drum.

In the following, the single-layered electrophotographic photoreceptor according to the present invention is shown and described in several examples. As these are described by way of an example, the examples should not be considered as limiting.

### EXAMPLES

### Example 1

The milling base is produced using Y-TiOPc as follows: In a reaction bowl, 6.3 g of Y-TiOPc was agitated and added to a solution in which 59.5 g of 1,1,2-tricholroethane (abbreviated TCE) was dissolved with 4.2 g of polycarbonate resin (PCZ 200 made by MITSHUBISHI CHEMICAL INC.). Then the solution was dispersed together with the glass beads with a paint shaker or a milling machine for more than 1 hour at 0° C. The dispersion liquid is obtained by straining out the glass beads that are used for the milling through a sieve.

The dispersion coating liquid, including the dispersion liquid, is produced as follows: The positive hole transfer material is a MPCT 10 (MITSHUBISHI PAPER MILL CO.) that is the charge transfer material of enaminstylbene polymer. The electron transfer material is 9-dicyanomethylene-9H-fluorene-4-carboxylic butyl ester (abbreviated BCMF). The binder resin is an O-PET™ (Trademark of JAPAN KANEBO CO.) of polyethylene terephthalate polymer.

MPCT 10 of 35 wt %, BCMF of 15 wt % and O-PET of 60 wt % are mixed in a 20 ml vial. Methylene chloride (abbreviated MC) and TCE are mixed in a ratio of 6:4, and dissolved in the mixture in the vial. To this solution, the dispersion base is added, and thus the final form of the coating liquid is obtained.

Then the coating liquid obtained as described above is coated on the substrate of the aluminum drum to form a single-layered electrophotographic photoreceptor.

### Example 2

Example 2 uses the same method as that of Example 1 except for dispersing the solution using 1,2-dichloroethane (DCE) instead of TCE.

### Example 3

Example 3 uses the same method as that of Example 1 except for dispersing the solution using monochlorobenzene (CB) instead of TCE.

### Example 4

Example 4 uses the same method as that of Example 1 except for dispersing the solution using dichlorobenzene (DCB) instead of TCE.

### Example 5

Example 5 uses the same method as that of Example 1 except for dispersing the solution using anisole instead of TCE.

### Example 6

Example 6 uses the same method as that of Example 1 except for using 1,4-dioxane instead of MC.

### Example 7

Example 7 uses the same method as that of Example 2 except for using 1,4-dioxane instead of MC.

### Example 8

Example 8 uses the same method as that of Example 3 except for using 1,4-dioxane instead of MC.

### Example 9

Example 9 uses the same method as that of Example 4 except for using 1,4-dioxane instead of MC.

### Example 10

Example 10 uses the same method as that of Example 5 except for using 1,4-dioxane instead of MC.

Comparison 1

Comparison 1 uses the same method as that of Example 1 except for dispersing the solution using 1,3-dioxolane instead of MC.

Comparison 2

Comparison 2 uses the same method as that of Example 2 except for dispersing the solution using 1,3-dioxolane instead of MC.

Comparison 3

Comparison 3 uses the same method as that of Example 3 except for dispersing the solution using 1,3-dioxolane instead of MC.

Comparison 4

Comparison 4 uses the same method as that of Example 4 except for dispersing the solution using 1,3-dioxolane instead of MC.

Comparison 5

Comparison 5 uses the same method as that of Example 5 except for dispersing the solution using 1,3-dioxolane instead of MC.

The samples of the examples 1-10 and comparisons 1-5 were used to produce an electrophotographic photoreceptor, and the thickness, the coating completeness, and the electric characteristics of the electro photographic photoreceptor were measured.

The measurements are shown in the Table 1 below:

TABLE 1

| | | | Quality | | | | | | |
|---|---|---|---|---|---|---|---|---|---|
| | | | of | E1/2 | | | | | T |
| | Solvent | Co-solvent | coating | (μJ/cm²) | Vₒ | V^{d} | V_{dis} | Vᵣ | (μm) |
| Example 1 | MC(6) | TCE(4) | Good | 0.169 | 493 | 462 | 75 | 32 | 11 |
| Example 2 | | DCE(4) | Good | 0.218 | 472 | 448 | 95 | 44 | 10 |
| Example 3 | | CB(4) | Good | 0.218 | 503 | 469 | 76 | 29 | 9 |
| Example 4 | | DCB(4) | Good | 0.182 | 518 | 481 | 72 | 30 | 10 |
| Example 5 | | Anisole(4) | Bad | 0.231 | 487 | 453 | 78 | 31 | 8 |
| Example 6 | 1,4- | TCE(4) | Worst | 0.2 | 533 | 489 | 110 | 46 | 12 |
| Example 7 | dioxane | DCE(4) | Worst | 0.222 | 468 | 439 | 98 | 44 | 9 |
| Example 8 | (6) | CB(4) | Worst | 0.269 | 508 | 474 | 122 | 54 | 9 |
| Example 9 | | DCB(4) | Worst | 0.22 | 524 | 485 | 112 | 50 | 12 |
| Example 10 | | Anisole(4) | Worst | 0.271 | 491 | 461 | 117 | 52 | 8 |
| Comparison | 1,3- | TCE(4) | Bad | 4.92 | 724 | 633 | 97 | 85 | 27 |
| 1 | dioxolane | | | | | | | | |
| Comparison | (across) | DCE(4) | Bad | 0.647 | 673 | 547 | 96 | 84 | 20 |
| 2 | (6) | | | | | | | | |
| Comparison | | CB(4) | Good | 0.485 | 656 | 526 | 96 | 83 | 21 |
| 3 | | | | | | | | | |
| Comparison | | DCB(4) | Bad | 4.89 | 728 | 650 | 97 | 86 | 24 |
| 4 | | | | | | | | | |
| Comparison | | Anisole(4) | Good | 0.505 | 663 | 535 | 96 | 82 | 20 |
| 5 | | | | | | | | | |

In the above Table 1, E ½(μJ/cm²) is the photo-sensitivity given by the needed photon energy when the initial charged voltage decreased by ½ during exposure. Vₒ is the initial electrification electric potential, and V_{d} is the electric potential after a 1 sec-dark decay.

V_{dis} is a light exposing electric potential, and Vᵣ is a residual electric potential after the light scanning. T(μm) is the thickness of the coating.

As shown in Table 1, using the TCE yields the best result in terms of sensitivity (Reverse of E ½).

According to the present invention, as described above, the single-layered electrophotographic photoreceptor comprises a charge generating material, a binder resin, and a charge transfer material on a substrate, wherein the charge generating material is Y form titanyloxy phthalocyanine in the milled dispersion liquid, and the binder resin is polyethylene therephtalate. Thus, the single-layered electrophotographic photoreceptor has excellent stability, electrical characteristics, sensitivity and durability.

The single-layered electrophotographic photoreceptor of the present invention may be manufactured in accordance with the procedures set forth above. In addition, the electrophotographic photoreceptor of the present invention may be installed in a cartridge or on a drum of an image forming apparatus.

As shown in the FIGURE, the single-layered electrophotographic photoreceptor of the present invention may be utilized in a photoreceptor cartridge 10, a drum 3, or in an image forming apparatus 9. The photoreceptor cartridge 10 typically comprises a single-layered electrophotographic photoreceptor 1 and at least one of a charging device 2 that charges the single-layered electrophotographic photoreceptor 1, a developing device 4 which develops an electrostatic latent image formed on the single-layered electrophotographic photoreceptor 1, and a cleaning device 6 which cleans a surface of the single-layered electrophotographic photoreceptor 1. The photoreceptor cartridge 10 may be attached to and detached from the image forming apparatus 9, and the single-layered electrophotographic photoreceptor 1 is described more fully above.

The photoreceptor drum 3 for an image forming apparatus 9, generally includes a drum that is attachable to and detachable from the image forming apparatus and that includes a single-layered electrophotographic photoreceptor 1 installed thereon, wherein the single-layered electrophotographic photoreceptor 1 is described more fully above.

Generally, the image forming apparatus 9 includes a photoreceptor unit (e.g., a photoreceptor drum 3), a charging device 2 which charges the photoreceptor unit, an imagewise light irradiating device/developer 4 which irradiates the charged photoreceptor unit with imagewise light to form an electrostatic latent image on the photoreceptor unit, a developing device which develops the electrostatic latent image with a toner to form a toner image on the photoreceptor unit, and a transfer device 5 which transfers the toner image onto a receiving material, wherein the photoreceptor unit comprises a single-layered electrophotographic photoreceptor 1 as described in greater detail above. In the embodiment shown in FIGURE, the paper from a paper supply unit 8 moves along the paper path 7.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A single-layered electrophotographic photoreceptor comprising:
a charge generating material;
a binder resin; and
a charge transfer material on a substrate:
wherein the charge generating material is titanyloxy phthalocyanine which has a following formula: 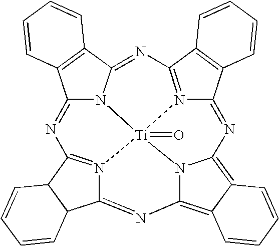
and the titanyloxy phthalocyanine is a crystal form which has at least 2 main peaks in a range of (2θ+−0.2)=9.5° to 27.3° of a Bragg angle in a characteristic CuKα X-ray diffraction spectrum; and
the binder resin is a polyethylene terephthalate polymer which has a following formula: 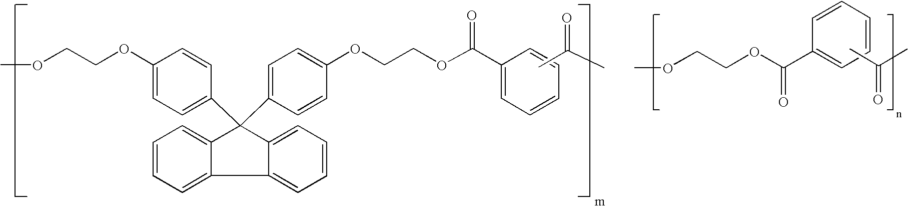
with n and m each being an integer that is equal to, or greater than, 1.

2. The single-layered electrophotographic photoreceptor according to claim 1, wherein the charge transfer material comprises a positive hole transfer material and an electron transfer material.

3. The single-layered electrophotographic photoreceptor according to claim 2, wherein the positive hole transfer material is an enaminstylbene polymer.

4. The single-layered electrophotographic photoreceptor according to claim 2, wherein the electron transfer material is 9-dicyanometylene-9H-fluorene-4-carboxylic butyl ester which has a following formula:

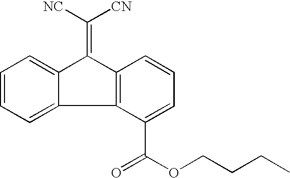

5. The single-layered electrophotographic photoreceptor according to claim 1, wherein the charge generating material is included in a dispersion liquid, the dispersion liquid including the charge transfer material, 1,1,2-trichlroethane as a solvent, and polycarbonate as another binder resin.

6. The single-layered electrophotographic photoreceptor according to claim 5, wherein the polycarbonate is in a range of 10 wt % to 90 wt %.

7. The single-layered electrophotographic photoreceptor according to claim 5, wherein the dispersion liquid is milled at a temperature below 15° C.

8. The single-layered electrophotographic photoreceptor according to claim 1, wherein the binder resin further includes polycarbonate and is a mixture of polycarbonate and polyethylene therephthalate polymer in a ratio of 1:99 to 99:1 by weight.

9. A method of manufacturing a single-layered electrophotographic photoreceptor comprising:
dispersing, with a binder resin and a predetermined solvent, a charge generating material, wherein the charge generating material comprises titanyloxy phthalocyanine which has a following formula: 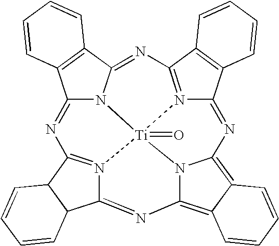
and the titanyloxy phthalocyanine is a crystal form which has at least 2 main peaks in a range of (2θ+−0.2)=9.5 to 27.3° of a Bragg angle in a characteristic CuKα X-ray diffraction spectrum; and the binder resin is a polyethylene terephthalate polymer which has a following formula: 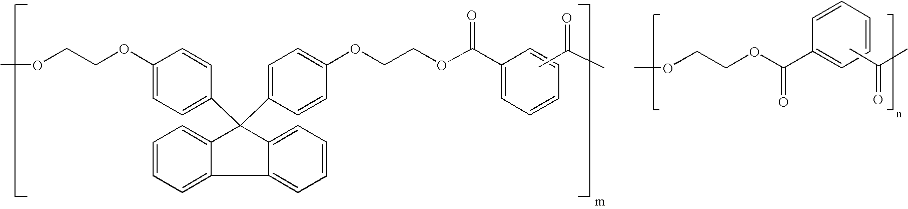
with n and m each being an integer that is equal to, or greater than, 1;
straining out dispersing materials to obtain a dispersion liquid;
dissolving, in a predetermined solvent, a charge transfer material comprising a positive hole transfer material, an electron transfer material and a binder resin to obtain a dissolved charge transfer material;
mixing the dispersion liquid with the dissolved charge transfer material to form a coating liquid; and
coating the coating liquid onto a substrate of a drum or cartridge to form a single-layered electrophotographic photoreceptor.

10. The method of claim 9 wherein the charge transfer material comprises a positive hole transfer material and an electron transfer material.

11. The method of claim 10, wherein the positive hole transfer material is an enaminstylbene polymer.

12. The method of claim 10, wherein the electron transfer material is 9-dicyanometylene-9H-fluorene-4-carboxylic butyl ester which has a following formula:

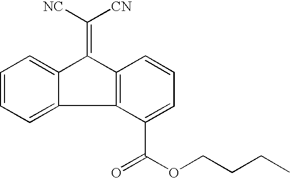

13. The method of claim 9, wherein the charge generating material is included in the dispersion liquid, the dispersion liquid including the charge transfer material, 1,1,2-trichlroethane as a solvent, and polycarbonate as another binder resin.

14. The method of claim 13, wherein the polycarbonate is in a range of 10 wt % to 90 wt %.

15. The method of claim 9, wherein the dispersion liquid is milled at a temperature below 15° C.

16. The method of claim 9, wherein the binder resin further includes polycarbonate and is a mixture of polycarbonate and polyethylene therephthalate polymer in a ratio of 1:99 to 99:1 by weight.

17. A single-layered electrophotographic photoreceptor in a photoreceptor cartridge of an image forming apparatus, the single-layered electrophotographic photoreceptor comprising:
a charge generating material;
a binder resin; and
a charge transfer material on a substrate,
wherein the charge generating material is titanyloxy phthalocyanine which has a following formula 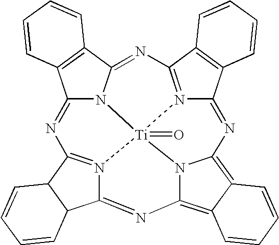
and the titanyloxy phthalocyanine is a crystal form which has at least 2 main peaks in a range of (2θ+−0.2)=9.5° to 27.3 of a Bragg angle in a characteristic CuKα X-ray diffraction spectrum; and
the binder resin is a polyethylene terephthalate polymer which has a following formula; 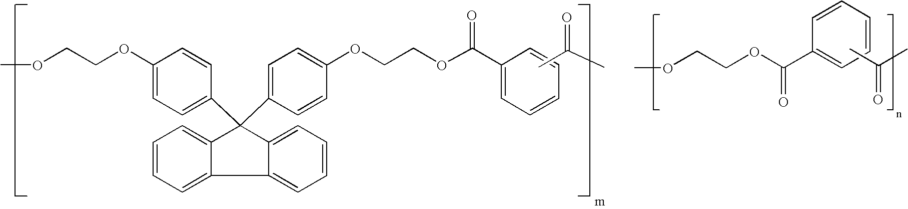
with n and m each being an integer that is equal to, or greater than, 1.

18. The single-layered electrophotographic photoreceptor of claim 17, wherein the charge transfer material comprises a positive hole transfer material and an electron transfer material.

19. A single-layered electrophotographic photoreceptor installed in a photoreceptor drum of an image forming apparatus, the single-layered electrophotographic photoreceptor comprising:
a charge generating material a binder resin; and
a charge transfer material on a substrate:
wherein the charge generating material is titanyloxy phthalocyanine which has a following formula: 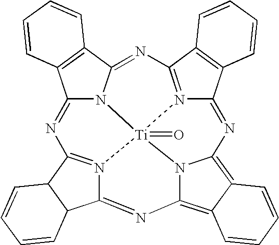
and the titanyloxy phthalocyanine is a crystal form which has at least 2 main peaks in a range of (2θ+−0.2)=9.5° to 27.3° of a Bragg angle in a characteristic CuKα X-ray diffraction spectrum; and
the binder resin is a polyethylene terephthalate polymer which has a following formula: 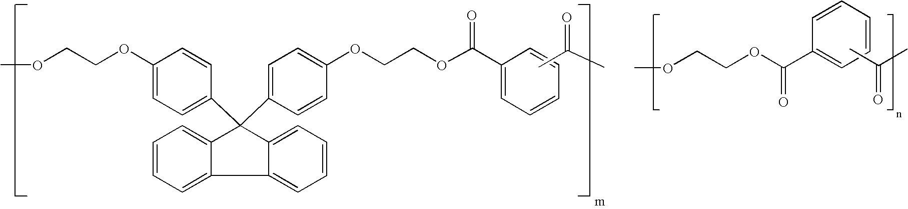
with n and m each being an integer that is equal to, or greater than, 1.

20. The single-layered electrophotographic photoreceptor of claim 19, wherein the charge transfer material comprises a positive hole transfer material and an electron transfer material.
